(19) United States
(12) Patent Application Publication
(10) Pub. No.: US 2026/0147429 A1
(43) Pub. Date: May 28, 2026

(54) DISPLAY DEVICE AND CONTROL METHOD OF DISPLAY DEVICE

(71) Applicant: Sharp Display Technology Corporation, Kameyama City (JP)

(72) Inventors: Kazuaki YOSHIDA, Kameyama City (JP); Kiyotsugu SUGIOKA, Kameyama City (JP)

(21) Appl. No.: 19/398,338

(22) Filed: Nov. 24, 2025

(30) Foreign Application Priority Data
Nov. 27, 2024 (JP) 2024-206249

(51) Int. Cl. G06F 3/041; G06F 3/044

(52) U.S. Cl. CPC G06F 3/0418; G06F 3/0412; G06F 3/044

(57) ABSTRACT

A display device includes a plurality of pixel electrodes, a plurality of drive electrodes, and a drive circuit that drives at least one of the plurality of drive electrodes. The drive circuit is configured to alternatingly execute driving at least one of the plurality of pixel electrodes in a display mode for image display, and driving at least one of the plurality of drive electrodes in a touch mode for touch sensing, supply a touch drive signal in pulse form to at least one of the plurality of drive electrodes in driving in the touch mode an n'th time, and supply a touch drive signal in pulse form, of which polarity is inverse as to the touch drive signal in pulse form in the n'th time, to at least one of the plurality of drive electrodes in driving in the touch mode an (n+1)'th time, n being a natural number.

### BACKGROUND

### 1. Field

The present technology relates to a display device and a control method of the display device.

### 2. Description of the Related Art

There are known so-called in-cell type touchscreen displays, in which part or all of a touch panel structure is built into a display device (e.g., Japanese Unexamined Patent Application Publication Nos. 2018-005882 and 2019-074989). In-cell type touchscreen displays use a display drive electrode as one sensor, and use a common electrode that is disposed facing the display drive electrode as the other sensor. Such in-cell type touchscreen displays are desirable as compared to on-cell type ones, in that a display can be realized that is thinner and more lightweight and that is highly bright, since there is no need to provide a touch panel structure on a display screen of the display.

An in-cell type display device having touch sensor functions executes a display drive period in which the display is driven, and a touch drive period in which the touch sensor function is executed within one frame period. Now, during the touch drive period, touch drive signals in pulse form are supplied to touch lines to which touch electrodes are connected, thereby detecting presence or absence of touching, and positions of touching. However, such touch drive signals in pulse form have an issue in that electromagnetic interference (EMI) noise is readily generated.

It is desirable to reduce electromagnetic interference noise during touch driving in a display device having touch sensor functions.

### SUMMARY

A display device includes a plurality of pixel electrodes, a plurality of drive electrodes, and a drive circuit that drives at least one of the plurality of drive electrodes. The drive circuit is configured to alternatingly execute driving at least one of the plurality of pixel electrodes in a display mode for image display, and driving at least one of the plurality of drive electrodes in a touch mode for touch sensing, supply a touch drive signal in pulse form to at least one of the plurality of drive electrodes in driving in the touch mode an n'th time, and supply a touch drive signal in pulse form, of which polarity is inverse as to the touch drive signal in pulse form in the n'th time, to at least one of the plurality of drive electrodes in driving in the touch mode an (n+1)'th time, where n is a natural number.

A control method of a display device including a plurality of pixel electrodes and a plurality of drive electrodes includes alternatingly executing driving at least one of the plurality of pixel electrodes in a display mode for image display and driving at least one of the plurality of drive electrodes in a touch mode for touch sensing, suppling a touch drive signal in pulse form to at least one of the plurality of drive electrodes in driving in the touch mode an n'th time, where n is a natural number, and suppling a touch drive signal in pulse form, of which polarity is inverse as to the touch drive signal in pulse form in the n'th time, to at least one of the plurality of drive electrodes in driving in the touch mode an (n+1)'th time.

### BRIEF DESCRIPTION OF THE DRAWINGS

FIG. 1 is a diagram illustrating a schematic system configuration of a display device according to an embodiment;

FIG. 2 is a diagram schematically illustrating part of a cross-sectional structure along a source line of the display device according to the embodiment;

FIG. 3 is a diagram schematically illustrating part of a partial structure along a gate line of the display device according to the embodiment;

FIG. 4 is a plan view schematically illustrating a configuration relating to touch sensing by the display device according to the embodiment;

FIG. 5 is a diagram conceptually illustrating signal waveforms that are applied to source lines, gate lines, and common electrodes, in accordance with drive modes in a conventional display device;

FIG. 6 is a diagram conceptually illustrating signal waveforms that are applied to source lines, gate lines, and common electrodes, in drive mode in the display device according to the embodiment;

FIG. 7 is a diagram conceptually illustrating directions of flow of currents flowing through the common electrode during a touch drive period, in the display device according to the embodiment;

FIG. 8 is a diagram schematically illustrating a detection circuit in a reset phase in the touch drive period in the display device according to the embodiment;

FIG. 9 is a diagram schematically illustrating a detection circuit in a sensing phase in the touch drive period in the display device according to the embodiment;

FIG. 10 is a diagram illustrating a structure for applying signals to a touch line of the display device according to the embodiment; and

FIG. 11 is a diagram schematically illustrating part of a partial structure along a gate line of the display device according to another embodiment.

### DESCRIPTION OF THE EMBODIMENTS

A display device according to one embodiment will be described below with reference to the drawings as appropriate. In the following an in-cell type touchscreen display (hereinafter may be referred to simply as “display device”) is exemplified as an embodiment of the display device, but the present technology is not limited thereto. Arrows X, Y, and Z in some of the drawings indicate directions intersecting each other (e.g., orthogonal), corresponding to a long-side direction, a short-side direction, and a thickness direction (normal direction of display face) of the display device, respectively.

### Configuration of Display Device

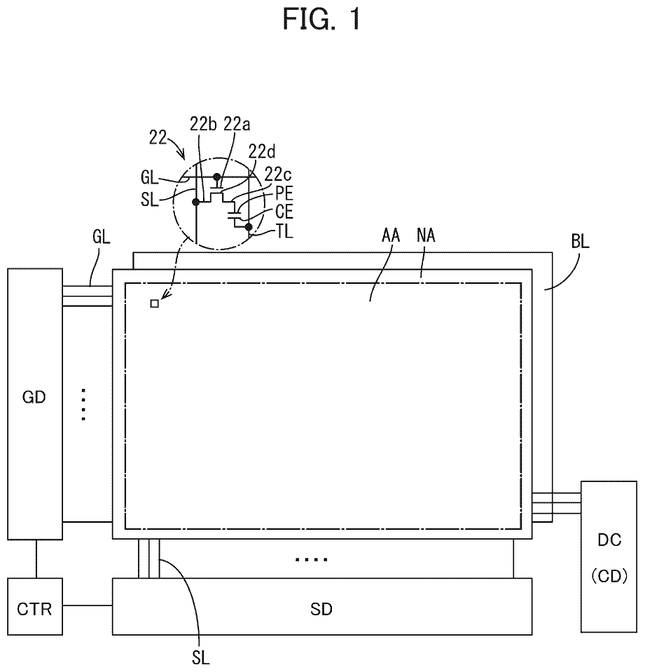

FIG. 1 is a plan view schematically illustrating a configuration of a display device according to the embodiment. The display device according to the present embodiment has a substantially rectangular plate-like form overall, and is equipped with a display panel 10 that is a principal portion of the display device. The display panel 10 displays images on the basis of image information, and also is configured to be capable of electrically rewriting displayed images. The display device is equipped with a plurality of source lines SL and a plurality of gate lines GL, and includes source drive unit SD that drives the plurality of source lines SL, a gate drive unit GD that drives the plurality of gate lines GL, a control circuit CTR that controls the source drive unit SD and the gate drive unit GD, and so forth.

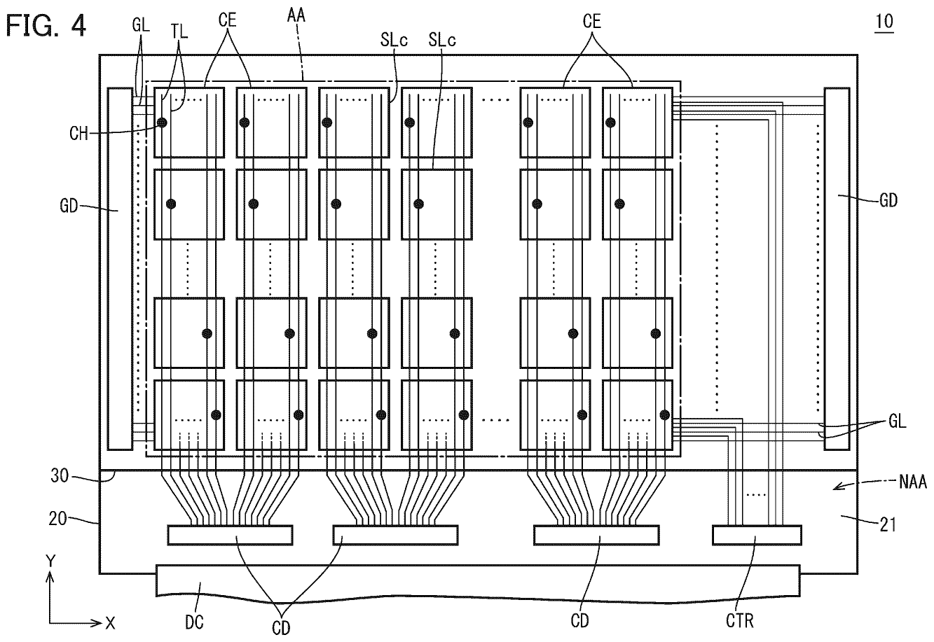

The display device according to the present embodiment is also configured to operate as a touch panel that has touch sensor functions. Specifically, the display panel 10 is equipped with a plurality of touch electrodes (e.g., see FIG. 4). The plurality of such touch electrodes may be touch-mode-only electrodes, to which touch drive signals are applied only when a drive mode is touch mode, or may be shared electrodes that are shared in common between both modes, in which display drive signals for displaying images (e.g., including common voltage and so forth) are applied when in display mode, and in which touch drive signals are applied when in touch mode.

Now, for example, in a case of using the plurality of touch electrodes as shared electrodes, or the like, a conventional common electrode that is formed continuously over substantially the entire face of the display region can be divided into a plurality of common electrodes (CE) in a matrix form, and thereby used as a plurality of touch electrodes. In this way, the touch electrodes may be in common with the common electrodes CE to which a common voltage (Vcom) that is common to all pixels is applied for image display.

In this case, in the display mode, the common voltage is applied to the plurality of touch electrodes that are also the plurality of common electrodes CE that the display panel 10 is equipped with, as display drive signals, for example, and in a case of driving in touch mode, touch drive signals are applied to at least one touch electrode.

In a case in which the display device is a liquid crystal display (LCD) device having in-cell type touch sensor functions, for example, the plurality of common electrodes CE that the display panel 10 is equipped with can be common electrodes to which the common voltage Vcom for forming an electric field is applied, corresponding to each pixel electrode to which pixel voltage is applied.

The present technology will be described below by way of an example in which the display device is equipped with the common electrodes CE as touch electrodes, for the sake of simplifying description. In this display device, the common electrodes CE to which the common voltage Vcom can be applied for image display are used as touch electrodes. Hereinafter touch electrodes may be referred to as common electrodes CE, without distinguishing functions thereof in particular.

As illustrated in FIG. 1, the display device according to the present embodiment is equipped with a backlight device BL on a rear face side of the display panel 10. The display panel 10 is arranged so as to be able to display image, utilizing illumination light that is emitted from the backlight device BL, for example. The display panel 10 includes a display region (active area) AA in which display images can be displayed, and a non-display region (non-active area) NA in which display images are not displayed.

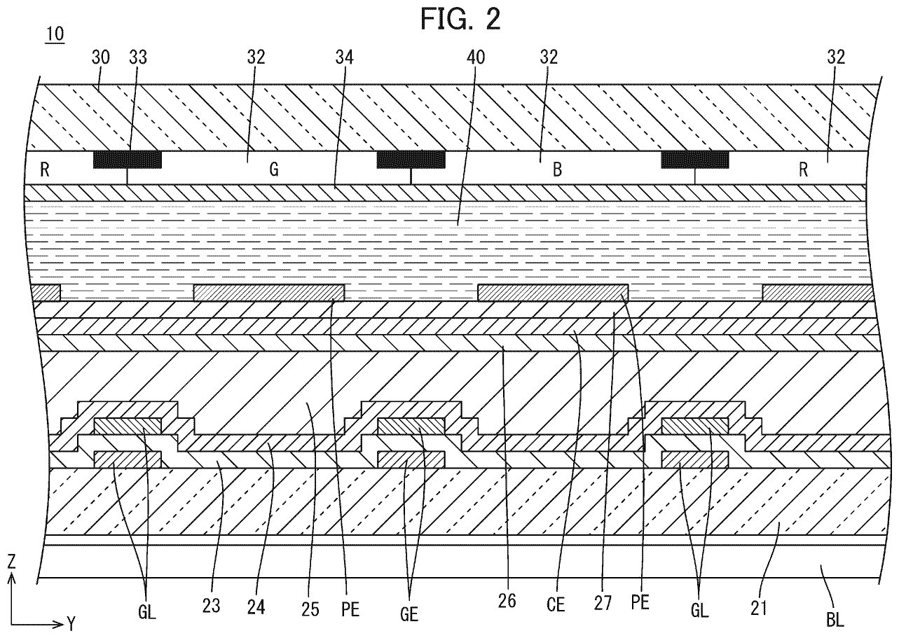

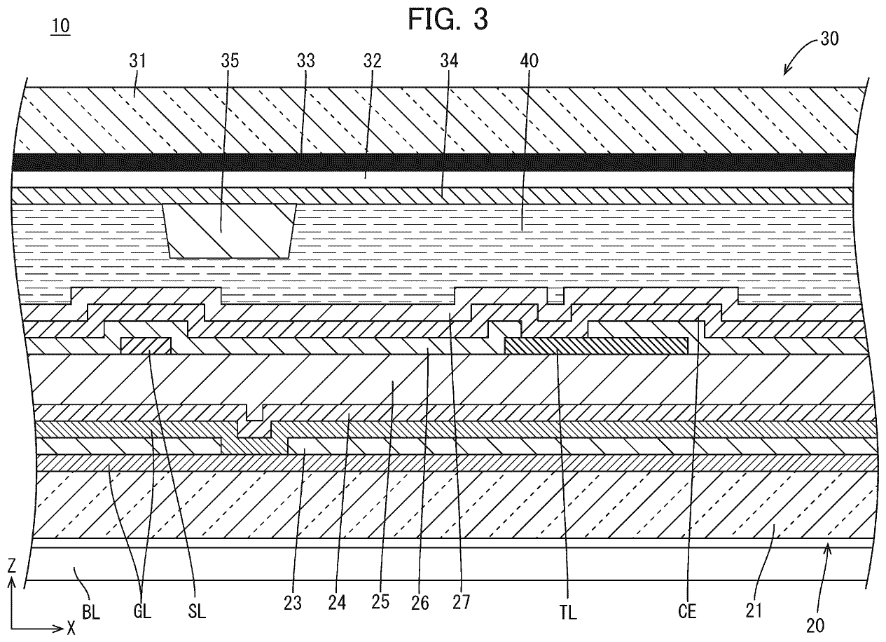

FIG. 2 is a diagram schematically illustrating part of a cross-sectional structure along a source line SL of the display device according to the embodiment. FIG. 3 is a diagram schematically illustrating part of a cross-sectional structure along a gate line GL of the display device according to the embodiment. The display device according to the present embodiment is a liquid crystal display device with a touch sensor. The display panel 10 is equipped with an array substrate 20 that is provided with a display circuit for image display, a counter substrate 30 that is disposed facing the array substrate 20, and a liquid crystal layer 40 that is disposed between the array substrate 20 and the counter substrate 30, as illustrated in FIGS. 2 and 3, for example. The display panel 10 is configured to be capable of controlling the amount of light from the backlight device BL that is transmitted, by controlling the alignment state of the liquid crystal by a drive circuit.

The array substrate 20 and the counter substrate 30 include glass substrates 21 and 31, respectively, that are substantially transparent (high transmissivity (e.g., 90% or higher) of visible light), and display circuits are provided on inner-side surfaces (opposing faces) of the glass substrates 21 and 31. A drive circuit DC is made up of various types of layers that are layered by photolithography or the like, for example. The array substrate 20 extends further outward in the Y direction for example, as compared to the counter substrate 30, with a drive circuit DC (e.g., gate drive unit GD, source drive unit SD, common electrode drive circuit CD) for supplying various types of signals relating to display functions and touch panel functions, a control substrate (e.g., control circuit CTR) via a flexible wiring board (not illustrated), and so forth, being mounted on this extending portion.

The array substrate 20 includes the plurality of gate lines GL extending in the long-side direction X and the plurality of source lines SL extending in the short-side direction Y, for example, on a display face side of the glass substrate 21, as described above. The display panel 10 is sectioned into a plurality of pixel regions by these gate lines GL and source lines SL. The pixel regions correspond to subpixels, for example. Switching devices (e.g., thin-film transistors (TFT)) are provided in each of the pixel regions. With respect to the switching devices, gate electrodes of the TFTs may be connected to the gate lines GL, source electrodes to the source lines SL, and drain electrodes to pixel electrodes PE that are transparent, respectively, for example. The pixel electrodes PE have shapes corresponding to the pixel regions (subpixels here). The display region AA may be occupied by the plurality of the pixel regions that are arrayed in matrix fashion, for example.

TFTs are driven (ON) on the basis of high-potential scanning signals (Gate H) that the gate drive unit GD supplies to the gate lines GL. The source electrode and the drain electrode conduct in conjunction with this driving, and also the source drive unit SD supplies image signals (source) to the source lines SL, whereby the pixel electrodes PE can be charged to a potential based on the image signals. The gate drive unit GD supplies scanning signals to the plurality of gate lines GL in order, and the source drive unit SD supplies images signals to the pixel electrodes that are driven so as to reach a pixel potential corresponding to the display image.

The array substrate 20 is provided with the common electrodes CE that form electric fields between themselves and the pixel electrodes PE by a common potential (reference potential) being supplied thereto. That is to say, the operation mode of the display panel 10 according to the present embodiment is fringe field switching (FFS) mode for example, the pixel electrodes PE and the common electrodes CE are both provided on the array substrate 20 side, with these pixel electrodes PE and common electrodes CE being disposed in different layers. The pixel electrodes PE are provided with slits that extend in an oblique direction with respect to the X direction and the Y direction in plan view, arrayed at intervals. In a case in which potential difference occurs between the common electrodes CE and the pixel electrodes PE disposed in different layers, the slits are arranged to apply a fringe field (oblique field) including a component in the normal direction as to a plate face of the array substrate 20, in addition to the component following the plate face of the array substrate 20. The configuration is such that the orientation state of liquid crystal molecules contained in the liquid crystal layer 40 can be appropriately switched, utilizing this fringe field.

FIG. 4 is a plan view schematically illustrating a configuration relating to touch sensing functions of the display device according to the embodiment. The array substrate 20 includes the plurality of touch electrodes (common electrodes CE) for executing touch sensor functions. The touch sensor functions realized in the present embodiment are in accordance with projected capacitance, for example, and the sensing thereof is by self-capacitance. The common electrodes CE are disposed in-layer in the display panel 10. The common electrodes CE are laid out in a matrix fashion in the display region AA of the display panel 10, as illustrated in FIGS. 2 and 3. The display region AA of the display panel 10 substantially matches a touch sensor region that is capable of detecting input positions. Accordingly, when a user brings a conductor, such as a finger of the user, a stylus, or the like, into close proximity with the surface (display face) of the display panel 10 in accordance with an image displayed in the display region AA of the display panel 10, for example, capacitance is formed between the position inputting member and the common electrodes CE. As the position input member comes closer, change occurs in the capacitance detected at the common electrodes CE in accordance with the distance thereof, and becomes a different capacitance from that of the common electrodes CE far away from the position input member. A detection circuit, which will be described later, can detect the input position on the basis of this difference in capacitance.

The plurality of common electrodes CE are disposed over substantially the entire region of the display region AA of the array substrate 20, and are divided into each of the common electrodes CE by slits SLc having a substantially grid form, for example. The size of the common electrodes CE in plan view is far greater than that of the pixel electrodes PE, and can be of a size extending over a plurality (around several tens to several hundreds) of pixel electrodes PE in the X direction and the Y direction, for example.

A plurality of touch lines TL are provided to the array substrate 20 in the Y direction. The touch lines TL extend in the Y direction, cutting across all common electrodes CE arrayed in a row in the Y direction. Also, each touch line TL is connected to a particular common electrode CE out of the plurality of common electrodes CE that it cuts across. FIG. 4 illustrates contact portions (contact holes) of the touch lines TL as to the common electrodes CE as solid dots. Note that depending on the number of touch lines TL disposed, just one touch line TL may come into contact with one common electrode CE, or a plurality of the touch lines TL may come into contact with one common electrode CE. Also, the number of touch lines TL that come into contact with one common electrode CE may differ in accordance with the positions of the common electrodes CE. In this case, setting the number of touch lines TL connected to common electrodes CE that are far away from the common electrode drive circuits CD to be greater than the number of touch lines TL connected to common electrodes CE that are close to the common electrode drive circuits CD, for example, is suitable, but is not limited to this.

One end of the touch lines TL in the Y direction is connected to the common electrode drive circuit CDs in the non-display region NA. The touch lines TL may extend further beyond the common electrodes CE that are the object of connection, on a side opposite to that of the common electrode drive circuits CD (to the upper side in FIG. 4). The touch lines TL may be connected to inspection circuits, static electricity control elements, and so forth, which are not illustrated, disposed in the non-display region NA on the side opposite to that of the common electrode drive circuits CD (upper side in FIG. 4). Further, the touch lines TL are connected to detection circuits. The detection circuits may be provided in the common electrode drive circuits CD, or may be provided externally from the display panel 10 via a flexible wiring board (not illustrated).

Another configuration of the display device as a liquid crystal display device will be described. As illustrated in FIGS. 2 and 3, a first conductive film, a first insulating film (gate insulating film 23), a semiconductor film, a second conductive film, a second insulating film 24, a planarization film (insulating film) 25, a third conductive film, a third insulating film 26, a first transparent electrode film, a fourth insulating film 27, and a second transparent electrode film, are layered on the array substrate 20 in order from a lower layer side (glass substrate 21 side).

The first conductive film makes up part of the gate lines GL, gate electrodes 22A of TFTs 22, and so forth. The second conductive film makes up part of the gate lines GL, source electrodes 22B and drain electrodes 22C of the TFTs 22, and so forth. The third conductive film makes up the source lines SL, the touch lines TL, and so forth. The first conductive film, the second conductive film, and the third conductive film are each a single-layer film made of one type of metal material selected from copper, titanium, aluminum, molybdenum, tungsten, and so forth, or a layered film made of different types of metal materials, or an alloy, and have conductivity and light blocking properties.

The semiconductor film makes up semiconductor portions 22D and so forth in the TFTs 22. The semiconductor film is made of a semiconductor material such as, for example, an oxide semiconductor, amorphous silicon, or the like. The first transparent electrode film makes up the common electrodes CE (touch electrodes) and so forth. The second transparent electrode film makes up the pixel electrodes PE and so forth. The first transparent electrode film and the second transparent electrode film are made of a transparent electrode material (e.g., indium tin oxide (ITO), indium zinc oxide (IZO), or the like).

The liquid crystal layer 40 (medium layer) contains liquid crystal molecules, which are a substance of which optical characteristics change in conjunction with application of an electric field. The liquid crystal layer 40 is disposed between the pair of the substrates 20 and 30. Note that on the inner-side surfaces of each of the array substrate 20 and the counter substrate 30 are provided alignment films (not illustrated) for causing alignment of the liquid crystal molecules contained in the liquid crystal layer 40. Also, polarization plates (not illustrated) are provided on the outer side surface of each of the array substrate 20 and the counter substrate 30.

Color filters 32 that are light-transmitting and that are of different colors from each other are provided on the inner side surface of the glass substrate 31 of the counter substrate 30, in the display region AA. The color filters 32 have the three colors of, for example, blue (B), green (G), and red (R), and are laid out arrayed between the source lines SL so as to be adjacent to a plurality of the source lines SL. In other words, the color filters 32 are arrayed following the direction in which the gate lines GL extend (substantially X direction). Thus, a plurality of the color filters 32 are arrayed as lateral stripes overall. These color filters 32 are laid out so as to be superimposed on the pixel electrodes PE of the array substrate 20 side in plan view. The color filters 32 and the pixel electrodes PE that are superimposed make up pixels (subpixels) that are display increments. Boundaries of the color filters 32 of different colors from each other (color boundaries) are disposed at positions superimposed on the gate lines GL. Also, on a lower layer side (liquid crystal layer 40 side) of the color filters 32, an overcoat film 34 is disposed so as to be provided in a solid manner over substantially the entire region of the counter substrate 30, for planarization.

Note that light-blocking portions 33 and spacers 35 are formed on the counter substrate 30 side. The light-blocking portions 33 block light between the pixel electrodes PE that are adjacent to each other. The light-blocking portions 33 also block light between the color filters 32 of different colors that are adjacent to each other. The light-blocking portions 33 are substantially grid-like in plan view, so as to be superimposed between pixel electrodes PE that are adjacent to each other, and have pixel openings so as not to overlap with the greater portion of the pixel electrodes PE in plan view. These pixel openings enable light passing through the pixel electrodes PE to be externally emitted from the display panel 10. The light-blocking portions 33 are laid out so as to be superimposed on at least the TFTs 22, the gate lines GL, the source lines SL, and the touch lines TL, on the array substrate 20 side, in plan view.

The spacers 35 are elements that maintain spacing between the pair of substrates 20 and 30. The spacers 35 have substantially circular shapes in plan view, for example. The spacers 35 are disposed near intersecting portions of the gate lines GL and the source lines SL provided to the array substrate 20. Note that the spacers 35 have a height that is equivalent to the cell thickness (distance between the array substrate 20 and the counter substrate 30, i.e., thickness of liquid crystal layer 40), and there are main spacers that function to hold the cell thickness uniform, and sub-spacers that are somewhat smaller than the main spacers heightwise, and that function to bear loads placed thereupon from outside of the cell. FIG. 3 illustrates an example in which the spacers 35 are sub-spacers, but the spacers 35 may be main spacers.

### Driving Method

Display devices generally supply driving power to the TFTs each time one frame (one image) is to be displayed. At this time, instead of supplying driving power to the TFTs continuously throughout the period of one frame, an “idle period” can be provided and power can be intermittently supplied to drive the TFTs, for example, depending on the display device. Accordingly, this idle period can be utilized to cause touch sensing to function by the touch electrodes assembled into the display device.

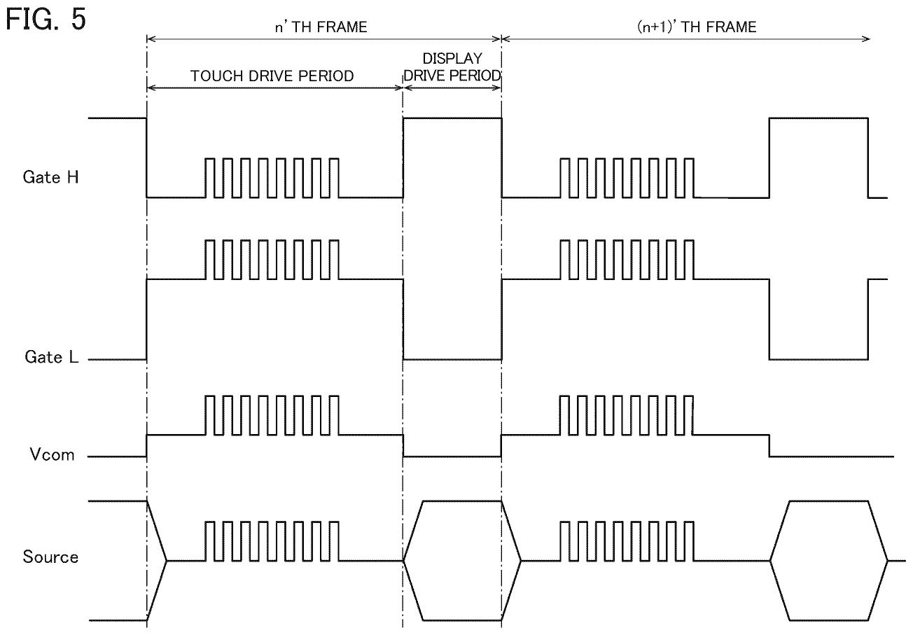

FIG. 5 is a general timing diagram of control signals for voltage to be applied to the gate lines GL, the touch lines TL, and the source lines SL in a conventional touchscreen display, exemplified for description. In the display device, the display mode for displaying images, and the touch mode for touch sensing, alternately operate within a display period of one frame. That is to say, with respect to the common electrodes CE (touch electrodes), common potential signals relating to image display functions and touch drive signals (position detecting signals) relating to touch panel functions are supplied in time division from the common electrode drive circuits CD. A period during which the display device is driven in display mode is referred to as a display drive period. Also, a period during which the display device is driven in touch mode is referred to as a touch drive period.

### Display Drive Period

The “Gate H” in FIG. 5 indicates timings of sending predetermined high-potential signals to the gate lines GL. During the display drive period, signals of a voltage level for turning the gates of the TFTs on, for example, are sent to the gate lines GL. “Gate L” indicates timings of sending predetermined low-potential signals to the gate lines GL. Low-potential signals are not sent to the gate lines GL during the display drive period, and later-described low-potential signals are sent at other than the display drive period, (i.e., during touch drive period). These high-potential signals and low-potential signals are supplied to, from among the plurality of gate lines GL, one gate line GL at a time in order, for example (scanning).

“Source” indicates timings of sending data signals to the source lines SL. During the display drive period, data signals corresponding to display content of the display are sent to the source lines SL, for example. For the data signals, data signals of a potential corresponding to display content of the gate lines GL (pixels), of which the gates are on, are transmitted in accordance with the scanning of the gate lines GL.

“Vcom” indicates timings of sending predetermined potential signals to the touch lines TL. During the display drive period, a common potential signal relating to image display functions can be sent to the touch lines TL, for example. This common potential signal is sent to all touch lines TL at the same timing (display period), for example. Accordingly, all common electrodes CE go to the reference potential based on the common potential signal, and function as the common electrodes CE. Note, however, that applying the common potential to the common electrodes CE does not necessarily have to be performed in the display drive period, and in the case of the timing diagram shown in FIG. 5 for example, the common potential signal is not sent in the display drive period.

### Conventional: Touch Drive Period

During the touch drive period, touch drive signals (e.g., Vcom) in pulse form are sent from the common electrode drive circuits CD to the touch lines TL. The common electrode drive circuits CD can use the common voltage for driving of the display to form touch drive signals (reference signals) for touch detection, by modulating in a pulsed pattern, for example. The common electrode drive circuits CD supply touch drive signals in pulse form for position detection to at least one touch line TL, for example. The common electrode drive circuits CD typically sequentially supply touch drive signals in pulse form for position detection to the plurality of touch lines TL. Now, the waveform of the touch drive signals can be, for example, square waves, triangle waves, sine waves, or the like, although not limited thereto in particular. Also, examples of frequency of the touch drive signals may include a predetermined frequency of around several tens of kHz to several hundred kHz, although not limited thereto in particular.

The common electrode drive circuits CD may supply pulse signals in pulse form for position detection to the plurality of touch lines TL at the same time. The common electrode drive circuits CD can execute sensing processing for sensing (detecting) presence or absence of touching and/or position of touching, utilizing signals received from at least one of a plurality of touch electrodes, regardless of whether the driving of the common electrodes CE is sequential driving or simultaneous driving.

Note that gate potential signals and source potential signals that are synchronous with the Vcom sent to the touch lines TL can be sent from the gate drive unit GD and the source drive unit SD to the gate lines GL and the source lines SL, such that abnormal potential difference does not occur in the display panel 10 during the touch drive period. The gate potential signals and the source potential signals, supplied to the gate lines GL and the source lines SL, respectively, may be the same signals as the position detection signals Vcom transmitted to the touch lines TL as one example, or may be different. It is desirable for at least one of voltage range and phase of the gate potential signals and the source potential signals supplied to the gate lines GL and the source lines SL, respectively, during the touch drive period, to be the same as the position detection signals Vcom transmitted to the touch lines TL, as one example. The gate potential signals and the source potential signals can be supplied to part or all of the plurality of source lines SL and the plurality of gate lines GL, and in a case of supplying to part, it is desirable for supplying to be performed to lines disposed at positions corresponding to the common electrodes CE to which touch drive signals (TDS) are applied.

However, this position detection signal Vcom is a pulse signal of a relatively high frequency that has a sharp rising edge and falling edge, and has an issue in that there is a possibility of making electromagnetic interference (EMI) noise worse.

### Embodiment: Touch Drive Period

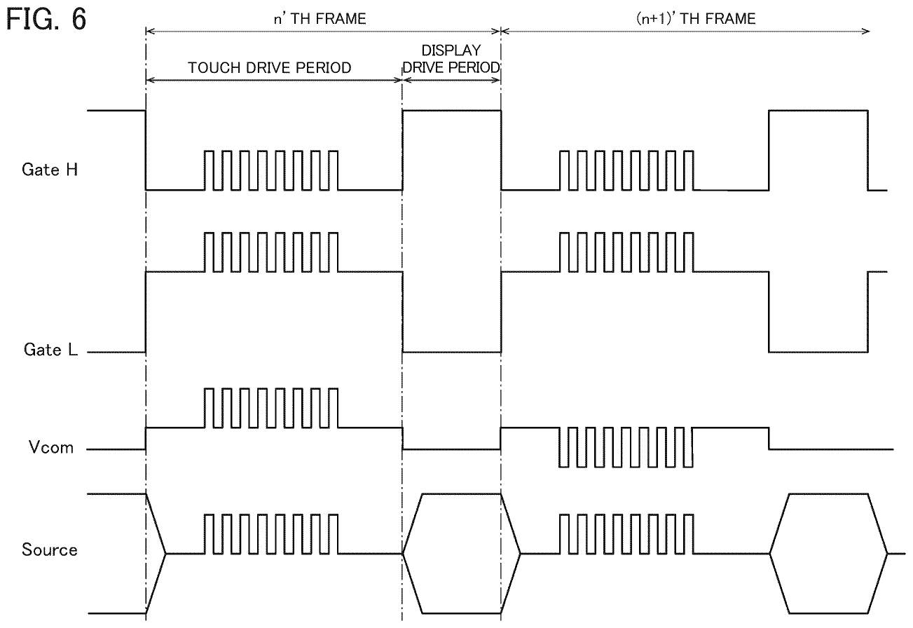

FIG. 6 is a general timing diagram of control signals for voltage to be applied to the gate lines GL, the touch lines TL, and the source lines SL in the display device according to the embodiment. In FIG. 6, the control signals in the display drive period are the same as those in the configurational example in FIG. 5. Accordingly, description of common configurations, and functions and effects, will be omitted.

Conversely, in the control signals in the touch drive period, the polarity of the common potential signal Vcom transmitted to the touch lines TL in the (n+1)'th frame is inverted with respect to the common potential signal Vcom sent to the touch lines TL in the n'th frame. That is to say, in the (n+1)'th frame, the common electrode drive circuits CD transmit the position detection signals Vcom, in which the predetermined common voltage in accordance with driving of the display has been modulated into a pulsed pattern with the polarity inverted as to the n'th frame, for example, to the touch lines TL. Note that n here is a natural number, and for example, n may be any natural number. Also, n may be continuous natural numbers, such as n=1, 2, 3 . . . or the like, for example, or may be natural numbers expressed by any function (e.g., an arithmetic progression such as n=3, 7, 11 . . . (4k−1, k=1, 2, 3 . . . ) or the like).

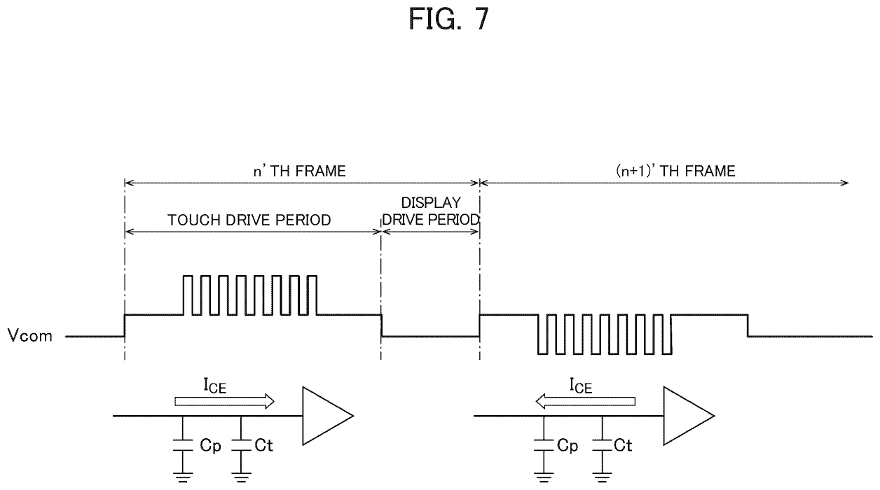

FIG. 7 is a diagram conceptually illustrating directions of flow of currents flowing through the common electrodes CE during the touch drive period, in the display device according to the embodiment. At this time, first, current is generated in the common electrodes CE by the pulsed voltage applied to the common electrodes CE in the n'th frame, as illustrated in FIG. 7. Also, magnetic flux spreads around the common electrodes CE due to this current. Now, at the time of rising of the pulsed voltage for example, the magnetic flux spreads from the common electrodes CE to the surroundings thereof, and at the time of falling of the pulsed voltage, the magnetic flux converges toward the common electrodes CE, and thus the phase of the magnetic flux is inverted between rising and falling of the voltage. Intensity of the magnetic flux is proportionate to the rate of change of the current, and accordingly a powerful magnetic flux is generated at the time of rising and falling of the voltage. Also, due to the voltage periodically changing, direction and density of the magnetic flux periodically changes. These can be factors of EMI. In the conventional touch drive method, such EMI can occur during the touch drive period every time.

Conversely, in the present technology, the polarity of the pulsed voltage applied to the common electrodes CE is inverted in the (n+1)'th frame. Accordingly, the direction of current flowing through the common electrodes CE due to application of the pulsed voltage is inverted from the preceding n'th frame. As a result, the phase of the magnetic flux generated from the common electrodes CE is inverted. That is to say, the magnetic fluxes cancel each other out between the n'th frame and the (n+1)'th frame. Accordingly, the overall EMI of the display device can be reduced.

The touch drive period of the n'th frame of outputting touch drive signals in a form of a relatively positive pulse (positive touch drive signals) will be referred to as “positive touch drive period”, and the touch drive period of the (n+1)'th frame of outputting touch drive signals in a relatively negative pulse form (negative touch drive signals) will be referred to as “negative touch drive period”. The negative touch drive period is provided to follow the positive touch drive period, with a display drive period interposed therebetween. In other words, the negative touch drive period for outputting negative touch drive signals is provided to follow the positive touch drive period for outputting positive touch drive signals, with the display drive period interposed therebetween. The common electrode drive circuits CD output negative touch drive signals in the next touch drive period following the positive touch drive period for outputting positive touch drive signals.

Performing such a combination of positive touch drive periods and negative touch drive periods at least one time contributes to reduction of EMI arising from magnetic flux fluctuation. The combination of positive touch drive periods and negative touch drive periods may be performed every predetermined frame count (e.g., 1000 frames) or predetermined time (e.g., 1 minute), for example. It is desirable for the combination of positive touch drive periods and negative touch drive periods to be performed repeatedly for all frames, for example. As one example, it is desirable to include a positive touch drive period for outputting positive touch drive signals in a 2m'th frame, and include a negative touch drive period for outputting negative touch drive signals in a (2m+1)'th frame, for example. In other words, it is desirable for the common electrode drive circuits CD to output positive touch drive signals in the 2m'th frame, for example, and to output negative touch drive signals in the (2m+1)'th frame. As a matter of course, an arrangement may be made including a negative touch drive period for outputting negative touch drive signals in the 2m'th frame, and including a positive touch drive period for outputting positive touch drive signals in the (2m+1)'th frame. In other words, the common electrode drive circuits CD may output negative touch drive signals in the 2m'th frame, for example, and output positive touch drive signals in the (2m+1)'th frame. Accordingly, the magnetic flux that is generated at the common electrodes CE can be cancelled out in each frame. As a result, the overall EMI of the display device can be effectively reduced.

### Sensing Circuit

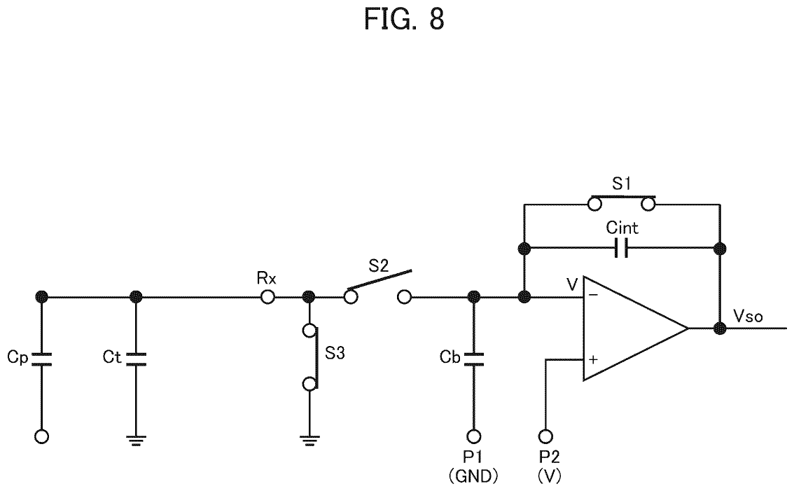

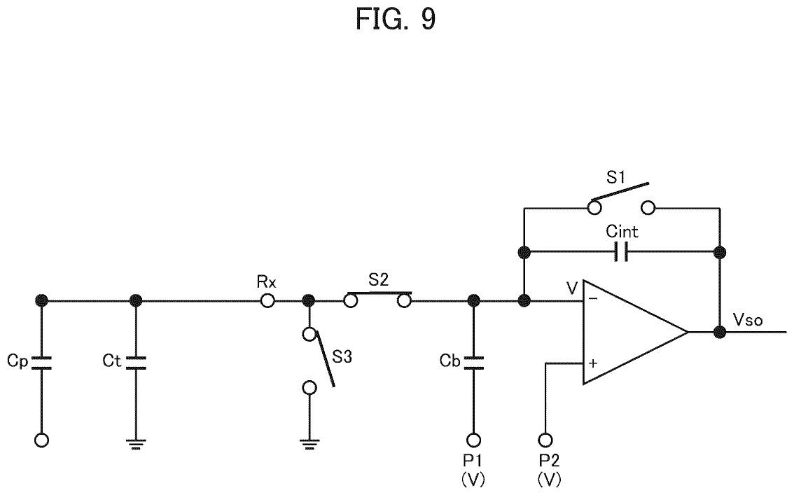

Description will be made regarding driving of touch electrodes (supply of touch device voltage) in a case in which the drive mode is touch mode. FIG. 8 is a diagram schematically illustrating a detection circuit in a reset phase in the touch drive period in the display device according to the embodiment. FIG. 9 is a diagram schematically illustrating the detection circuit in a sensing phase in the touch drive period in the display device according to the embodiment.

FIGS. 8 and 9 schematically illustrate a configuration of a touch line TL and a detection circuit (single-end charge integrator) thereof, connected to any (e.g., n'th) touch line TL. Principal configurations of the circuit and the symbols in FIGS. 8 and 9 are described below.

A touch drive power source V is connected to a non-inverting input terminal of an op amp. Output of the op amp is connected to an inverting input terminal via a feedback capacitance Cint, and a reset switch S1 parallel to this feedback capacitance Cint. Also, a detection electrode Rx is connected by single-end configuration to an inverting input terminal of the op amp, via an input switching switch S2. Parasitic capacitance Ct (capacitance) due to touching the common electrode CE, and parasitic capacitance Cp with the pixel electrode PE, the gate line GL, the source line SL, and so forth, are generated at the detection electrode Rx. Also, a signal line that is connectable to a ground GND or the touch drive power source V is connected between the inverting input terminal and the input switching switch S2, via a biasing capacitor Cb. This op amp functions as a charge integrator, and detects change in capacitance due to touching the common electrode CE as voltage, by integrating and amplifying minute signals input to the sensing line.

### Input Portion

Ct: capacitance due to touching (parasitic capacitance)
Cp: parasitic capacitance between common electrode CE and gate line GL, source line SL, and so forth
Rx: Detection electrode

### Feedback Portion

Cint: Feedback capacitance (integrated capacitance)
S1: Reset switch

### Switching Portion

S2, S3: Input switching switches
Cb: Biasing capacitor

### Amplifying Portion

Op amp
V_{SO}: Output voltage
P1: First contact point (potential: GND or V)
P2: Second contact point (potential: V)

Operations of the detection circuit are controlled by the control circuit CTR as follows, for example. In the “reset phase”, the reset switch S1 and the input switching switch S3 are set to on, while the input switching switch S2 is set to off, as illustrated in FIG. 8. A first potential of a first contact point P1 is connected to GND, and a second contact point P2 is connected to touch drive power source V. Accordingly, the feedback capacitance Cint can be discharged, and the biasing capacitor Cb can be charged to the input voltage V of the second contact point, thereby initializing the circuit. Note that a charge Q of the biasing capacitor Cb is expressed by an expression Q=Cb×V.

In the “sensing phase”, the reset switch S1 and the input switching switch S3 are switched to off, while the input switching switch S2 is switched to on, as illustrated in FIG. 9. Note that the input voltage of the first contact point P1 is connected to the same voltage V as that of the input voltage of the second contact point P2. Thus, the input voltage V can be applied to the detection electrode Rx. Note that at this time, the charge Q that had been charged to the biasing capacitor Cb is redistributed to the capacitances of the detection circuit. Now, when a position input member such as a finger or the like is present in the proximity of the common electrode CE, the capacitance Ct, which is capacitance to ground, increases, and the proportion of the charge Q distributed to the feedback capacitance Cint decreases. The detection circuit detects this decrease in charge Q as output voltage V_{SO}.

Now, conventionally, in addition to the parasitic capacitance Cp between the common electrode CE and the gate line GL, source line SL, and so forth, EMI due to supply of input voltage V for touch driving, and so forth, entered the touch system via the parasitic capacitance. This results in increase in the parasitic capacitance Cp, to where the proportion of the charge Q distributed to the feedback capacitance Cint (i.e., the change in capacitance Ct of the common electrode CE due to touching) becomes minute even in a case in which the position input member such as a finger or the like is present in the proximity of the common electrodes CE, and there is concern that detection may not be able to be performed, or the effects of noise may be non-negligible.

Conversely, according to the present technology, the polarity of input voltage (position detecting signal Vcom) supplied to the common electrode CE during the touch drive period is switched. Accordingly, the effects of EMI can be reduced. For example, switching the polarity of the position detection signal Vcom supplied to the common electrode CE at each frame in the touch drive period enables the parasitic capacitance Cp to be cancelled (made unobservable). As a result, the charge Q of the biasing capacitor Cb is redistributed into just the two of the feedback capacitance Cint and the capacitance Ct due to touching. Thus, the effects of EMI and the parasitic capacitance Cp can be suppressed and touch drive signals can be detected with high precision.

### Additional Circuit

A configuration for switching the polarity of the input voltage V to be supplied to the common electrodes CE during the touch drive period such as in the above will be described.

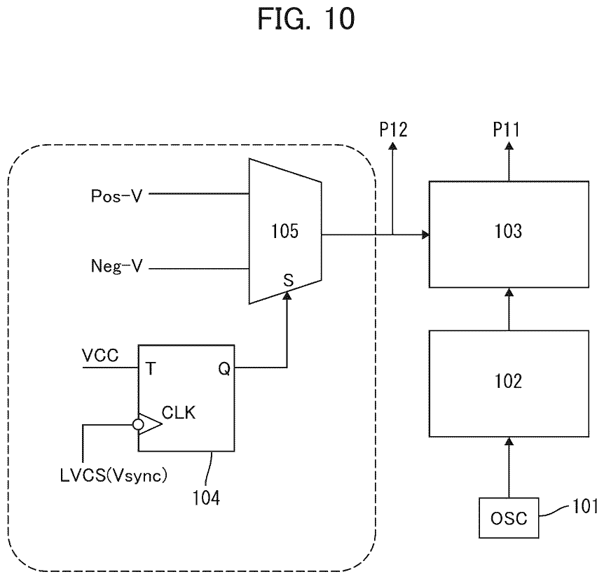

FIG. 10 schematically illustrates a power source circuit for input to the detection circuit. Unconnected terminals P11 and P12 in FIG. 10 can be connected to the first contact point P1 and the second contact point P2 in FIGS. 8 and 9. In FIG. 10, an oscillator 101, a touch logic circuit 102, and a sensing generator 103, which are illustrated to the right side, are generally in common with a configuration of a touch drive power source provided to conventional detection circuits. The power source circuit in the present technology further includes a T flip-flop 104 and a multiplexer 105, which are surrounded by a dotted line in FIG. 10. The components will be described below.

The oscillator 101 generates periodic timing signals in the form of square waves or pulse signals, for example. The oscillator 101 provides clock signals or timing signals used for the entire display device to operate, for example. Thus, the detection circuits, drive circuits, and so forth, of the display device, can be synchronized.

The touch logic circuit 102 is a component that plays a central role in control of the touch sensor function. For example, the touch logic circuit 102 controls timings of various types of operations, on the basis of reference clock signals from the oscillator 101. The various types of operations include, for example, sensing, sampling, resetting (switching of switches), display driving, and so forth, synchronization therewith, and so on. The touch logic circuit 102 also instructs the sensing generator 103 that is downstream to generate touch drive signals in pulse form, such that touch driving can be suitably carried out in the display device.

The sensing generator 103 generates touch driving voltage in pulse forms, in order to drive the touch electrodes. In other words, the sensing generator 103 generates driving voltage for sensing. Upon instruction from the touch logic circuit 102, the sensing generator 103 generates voltage in accordance with the form and timing instructed. Upon instruction from the T flip-flop 104, the sensing generator 103 generates voltage in accordance with the form and timing instructed. The sensing generator 103 may be a signal generator, for example.

The T flip-flop 104 is a type of flip-flop circuit that can hold one of two states, and the value of output thereof is inverted in accordance with change in the value of one input. This T flip-flop 104 has, for example, an inter terminal T for inputting an operation power source VCC, and a terminal CLK for inputting a clock signal, with output Q being inverted each time there is input of the CLK signal. For example, inputting vertical synch signals Vsync indicating starting and ending timings of a touch drive period by low-voltage differential signaling (LVDS) to the terminal CLK causes the output Q to be switched so as to alternate between “0” and “1” each time the vertical synch signal Vsync is input. Accordingly, voltage to be selected can be controlled depending on whether the count of the vertical synch signals Vsync is even (e.g., 2m) or odd (e.g., 2m+1). The output Q of the T flip-flop 104 is sent to the multiplexer 105 that is downstream as a selection signal S.

The multiplexer 105 is also referred to as a multiplexor, combiner, channelizer, and so forth, and outputs two or more inputs as one signal. The multiplexer 105 is equipped with two input terminals, of which a first input terminal is Pos-V and a second input terminal is Neg-V, and these indicate the power source to be supplied to the sensing generator 103. The multiplexer 105 takes the output Q of the T flip-flop 104 as the selection signal S, and selects and outputs one of the first input that is Pos-V and the second input that is Neg-V in accordance therewith. The multiplexer 105 can output first input that is Pos-V when the output Q (selection signal S) from the T flip-flop 104 is “0”, for example, and the second input that is Neg-V when the output Q is “1”, as the power source for the sensing generator 103. This multiplexer 105 can alternatingly switch the polarity of the output voltage V generated by the sensing generator 103 each time the vertical synch signal Vsync is generated.

According to the above embodiment, a display device is provided that includes a plurality of pixel electrodes PE, a plurality of common electrodes CE (example of drive electrode), and a drive circuit for driving at least one of the plurality of common electrodes CE (e.g., common electrode drive circuit). This common electrode drive circuit CD alternately executes driving at least one of the plurality of pixel electrodes PE in display mode for image display, and driving at least one of the plurality of common electrodes CE in touch mode for touch sensing. Then, in driving in touch mode the n'th time, a touch drive signal in pulse form is supplied to at least one of the plurality of drive electrodes. Then, in driving in touch mode the (n+1)'th time, a touch drive signal in pulse form of inverse polarity from the touch drive signal in pulse form in the n'th time is supplied to at least one (typically all) of the plurality of common electrodes CE.

According to such a configuration, magnetic flux formed on the common electrodes CE at the time of touch mode driving the n'th time is cancelled out by inverse magnetic flux formed by supplying the touch drive signal in pulse form with the opposite sign in the (n+1)'th time. As a result, the apparent magnetic flux disappears, and EMI is reduced. Also, the above configuration can be realized simply by adding, to a conventional touch mode drive device, a mechanism for inverting the polarity of power that is supplied.

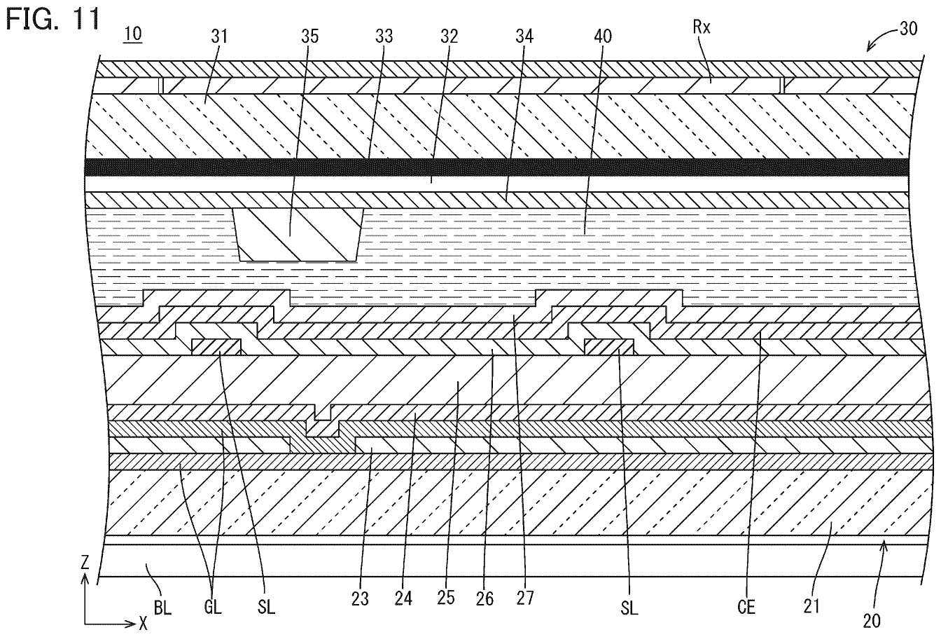

While an embodiment according to the present technology has been described above in detail, this is only exemplary, and does not limit the Claims. Technology described in the Claims includes various modifications and alterations of the specific example exemplified above. For example, the above-described embodiment is only a detailed description for facilitating understanding of the present disclosure, and is not necessarily limited to including all configurations described therein. Also, part of configurations of a certain embodiment can be substituted with other configurations, and also other configurations can be added to the configurations of a certain embodiment. Also, other configurations can be added to, deleted from, and substituted for part of configurations of the embodiment.
(1) Description has been made in the above embodiment regarding a display device in which a self-capacitance system that detects change in capacitance between a finger for example (position input member) and touch electrodes (common electrodes CE) is employed as the touch sensor system. The present technology is not limited to application to the display device that is provided with touch sensor functions of detection by self-capacitance. The display device may be a display device that has touch sensor functions of detection by mutual capacitance, in which change in capacitance between two touch electrodes is detected, for example. In the display device of the mutual capacitance system, a drive electrode to which a touch drive signal is applied (transmitting electrode), and a receiving electrode corresponding to this drive electrode, are utilized to detect change in capacitance between the two touch electrodes (drive electrode and receiving electrode), thereby detecting presence or absence of touching, and/or positions of touching or the like. In a display device having such mutual-capacitance detection touch sensor functions, the drive electrodes to which the touch drive signals (TDS) are applied, out of the two touch sensors, are equivalent to the common electrodes CE to which the drive signals in pulse form are applied to in the present technology.
(2) In the above embodiment, the common electrodes CE serving as touch electrodes are connected to the touch lines TL that the array substrate 20 is equipped with. Also, the detection circuit that senses change in capacitance of the common electrodes CE is connected to the touch lines TL. However, the form of detecting change in capacitance is not limited to this. For example, the common electrodes CE may be provided to the array substrate 20, and the detection electrode Rx for detecting change in capacitance may be provided on the counter substrate 30, as illustrated in FIG. 11. In this case, the common electrode drive circuits CD may supply drive signals in pulse form to the common electrodes CE and the detection electrode Rx. The detection circuit can detect presence or absence of touching, and position, with relation to the change in parasitic capacitance between the common electrodes CE and the detection electrode Rx.
(3) In the above embodiment, touch drive signals are sent to the common electrodes CE (touch electrodes) via the touch lines TL disposed following the source lines SL, during the touch drive period in which the display device operates in touch mode. Each touch line TL is selectively connected to one common electrode CE in the above description. However, the touch lines TL may be connected to a plurality of the common electrodes CE. For example, the detection circuit may be able to sense presence or absence of touching, and position of touching, by outputting touch drive signals in pulse form, for driving at least one of a plurality of the touch electrodes electrically linked via the source lines SL, during the touch drive period in which the display device operates in touch mode.

The detection circuit may sequentially drive at least one of the plurality of touch electrodes, for example, or may drive all of the touch electrodes at the same time. The detection circuit can sense presence or absence of touching, and position of touching, utilizing signals received from at least one of the plurality of touch electrodes, regardless of whether the touch electrodes are sequentially driven or all driven at the same time. Also, the detection circuit can detect change in capacitance, and sense presence or absence of touching, and position of touching, on the basis of change in the capacitance that is detected.

Note that in a case of self-capacitance touch sensor functions, touch drive signals are applied to the touch electrodes (common electrodes CE), and change in capacitance is detected at the touch electrodes (common electrodes CE) to which the touch drive signals are applied, and accordingly the touch electrodes (common electrodes CE) in this self-capacitance system can be said to playing the role of both drive electrodes and receiving electrodes in the mutual-capacitance system.
(4) Description has been made in the above embodiment regarding a case in which the display device is a liquid crystal display device having in-cell touch sensor functions. However, the display device is not limited to liquid crystal display devices. In a case in which the display device is an electronic paper display device that has in-cell touch sensor functions, for example, the plurality of common electrodes CE that the display panel 10 is equipped with may be common electrodes to which common voltage Vcom is applied to form electric fields, corresponding to the pixel electrodes (back electrodes) of an electronic paper unit to which pixel voltage is applied.

Also, as another example, in a case in which the display device is an organic light-emitting display (OLED) that has in-cell touch sensor functions, the plurality of common electrodes CE that the display panel 10 is equipped with may be cathode electrodes (common electrodes) of organic light-emitting diodes corresponding to anode electrodes (pixel electrodes) of the organic light-emitting diodes.
(5) In the detection circuit according to the above embodiment, V_{SO} output from the op amp is taken as output voltage. However, as for the output voltage, a value obtained by performing capacitance detection operations a plurality of times and performing averaging processing of the plurality of detected capacitances may be employed as the output voltage, in order to distinguish between capacitance (change) signals from touching, and noise.
(6) In the embodiment, one frame period includes one set of display drive period and touch drive period. However, one frame period may be time-divided into one or more display drive periods and one or more touch drive periods.

The present disclosure contains subject matter related to that disclosed in Japanese Priority Patent Application JP 2024-206249 filed in the Japan Patent Office on Nov. 27, 2024, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A display device, comprising:
a plurality of pixel electrodes;
a plurality of drive electrodes; and
a drive circuit that drives at least one of the plurality of drive electrodes, wherein
the drive circuit is configured to
alternatingly execute
driving at least one of the plurality of pixel electrodes in a display mode for image display, and
driving at least one of the plurality of drive electrodes in a touch mode for touch sensing,
supply a touch drive signal in pulse form to at least one of the plurality of drive electrodes in driving in the touch mode an n'th time, and
supply a touch drive signal in pulse form, of which polarity is inverse as to the touch drive signal in pulse form in the n'th time, to at least one of the plurality of drive electrodes in driving in the touch mode an (n+1)'th time,
where n is a natural number.

2. The display device according to claim 1, further comprising:
a plurality of gate lines; and
a plurality of source lines, wherein
the plurality of pixel electrodes are each connected to the plurality of gate lines and the plurality of source lines via switching devices, and are laid out in matrix form.

3. The display device according to claim 1, wherein the plurality of drive electrodes are common electrodes that provide common potential in the display mode.

4. The display device according to claim 1, wherein the drive circuit includes a detection circuit that outputs the touch drive signal in pulse form to drive at least one of the plurality of drive electrodes, and detects presence or absence of touching, or a position of touching.

5. The display device according to claim 1, wherein the drive circuit includes a detection circuit that outputs the touch drive signal in pulse form and detects presence or absence of touching, or a position of touching.

6. The display device according to claim 5, wherein the detection circuit includes a sensing generator that generates the touch drive signal in pulse form, and a switching circuit that switches between positive voltage and negative voltage for a power source of the sensing generator.

7. A control method of a display device including a plurality of pixel electrodes and a plurality of drive electrodes, the method comprising:
alternatingly executing
driving at least one of the plurality of pixel electrodes in a display mode for image display, and
driving at least one of the plurality of drive electrodes in a touch mode for touch sensing;
suppling a touch drive signal in pulse form to at least one of the plurality of drive electrodes in driving in the touch mode an n'th time, where n is a natural number; and
suppling a touch drive signal in pulse form, of which polarity is inverse as to the touch drive signal in pulse form in the n'th time, to at least one of the plurality of drive electrodes in driving in the touch mode an (n+1)'th time.
